(19) United States
(12) Patent Application Publication
(10) Pub. No.: US 2010/0006074 A1
(43) Pub. Date: Jan. 14, 2010

(54) EGR VALVE ASSEMBLY

(76) Inventor: Werner DENGLER, Nueziders (AT)

Correspondence Address: K.F. ROSS P.C., 5683 RIVERDALE AVENUE, SUITE 203 BOX 900, BRONX, NY, 10471-0900, US

(21) Appl. No.: 12/499,903

(22) Filed: Jul. 9, 2009

(30) Foreign Application Priority Data
Jul. 10, 2008 (DE) 102008032436.1

(51) Int. Cl. F02M 25/07

(52) U.S. Cl. 123/568.11

(57) ABSTRACT

The invention relates to an exhaust-gas-recirculation valve (1) of an internal-combustion engine comprising a housing with an inlet (2) for the supply of exhaust gas of the internal-combustion engine, and with at least one outlet (3, 4) for the recirculation of a portion of the exhaust gas into the combustion air supply of the internal-combustion engine, with a conduit passage between the inlet (2) and the outlet (3, 4) being able to be opened or closed by a valve body, and with an actuator being provided that moves the valve body, in order to open or close the conduit passage between the inlet (2) and the outlet (3, 4). The invention provides that the port (5) of the inlet (2) and the port (6, 7) of the outlet (3, 4) are arranged in planes (10, 11) plane-parallel relative to each other, or in one plane (12), and that the valve body is comprised as a seal plate (8) embodied for the purpose of unblocking or blocking the port (5) of the inlet (2) and the port (6, 7) of the outlet (3, 4), in order to open or close the conduit passage between the inlet (2) and the outlet (3, 4).

The invention relates to exhaust-gas-recirculation valve of an internal-combustion engine comprising a housing with an inlet for the supply of exhaust gas of the internal-combustion engine and at least one outlet for the recirculation of a portion of the exhaust gas into a combustion air supply of the internal-combustion engine, a conduit passage between the inlet and the outlet openable or closable by a valve body, and an actuator that moves the valve body to open or close the conduit passage between the inlet and the outlet, as recited in the preamble of claim 1.

Exhaust gas recirculation (EGR) is used for the reduction of nitrogen oxides generated when fuel is burnt inside internal-combustion engines, such as Otto or diesel engines. The reduction is particularly necessary to comply with today's mandated emission standards. In diesel engines such standards also serve to reduce noise, whereas in Otto engines it is possible to reduce fuel consumption with exhaust gas circulation. With high combustion temperatures the nitrogen oxides harmful to the environment increase inside the internal-combustion engine. To reduce nitrogen oxides the combustion temperature must be lowered, which is why a portion of the exhaust gas of the internal-combustion engine is added to the aspirated fresh intake air in the part-load operational range via a conduit to the intake manifold of the internal-combustion engine. An exhaust-gas-recirculation valve placed outside the engine (external exhaust gas recirculation) assumes control for this, with the valve being comprised of an inlet to which exhaust gas of the internal-combustion engine is supplied and with the valve having a valve body whose position determines whether exhaust gas is recirculated to the intake manifold of the internal-combustion engine, so that the portion of the exhaust gas in the part-load operational range can be added to the aspirated fresh air.

To effect the exhaust gas recirculation, exhaust-gas-recirculation valves to which the exhaust gas from the combustion manifold of the internal-combustion engine is supplied have already become known that supply a portion of the exhaust gas to the intake manifold of the internal-combustion engine by the exhaust-gas-recirculation valve via one or two outlets. The exhaust-gas-recirculation valve has an actuator that is operated by a controller in dependence on the parameters of the internal-combustion engine. This makes it possible to control the quantity of the exhaust gas supplied to the exhaust-gas-recirculation valve that can be supplied to the intake manifold of the internal-combustion engine.

Known exhaust-gas-recirculation valves comprise a housing having an inlet and one or two outlets. Here, the inlet for the exhaust gas and the one outlet or both outlets are set approximately at a right angle to each another. A piston rod that can be moved by an actuator is mounted inside the housing, with two disks spaced apart from each other arranged on the piston rod, with the disks being movably disposed in the interior of the cylindrical housing. Axial displacement of these two valve bodies either completely closes (no exhaust gas recirculation) the conduit passage between the inlet and the outlet (or the two outlets) or partially or completely opens it (partial or complete recirculation of the exhaust gas supplied to the exhaust-gas-recirculation valve). Such a design, however, has the disadvantage that very tight tolerances must be maintained, so that two axially movable seals inside the housing of the exhaust-gas-recirculation valve abut in a sealing manner within the housing, radially extending to the housing's inner surface, if the conduit passage between the inlet and the outlet is to be completely sealed and closed.

Older exhaust-gas-recirculation valves consist of a bypass flap and an exhaust-gas-recirculation valve. Thus, they comprise a sensor system that determines the position of the valve body in the exhaust-gas-recirculation valve as well as two actuators. This complexity is reflected in the costs.

Newer generations, as initially described, combine both actuators in a 1-port/2-way valve, each controlling one of the two functions, bypass or exhaust gas recirculation, in a linear manner with a piston and a piston rod. Cost is reduced for sensors and actuators. The high actuating and reset forces present a problem in this connection with the so-called “fail safe” function, as well as the cost-intensive sealing of the individual valve flow paths by extremely precise pistons, valve bodies and valve seats. The “fail safe” function is necessary, so that, for example, in case the actuator breaks down, the conduit passage between the inlet and the outlet is blocked (closed), so that the internal-combustion engine can now still be operated without exhaust gas recirculation.

Thus, the object of the invention is to avoid the disadvantages described above and provide a system for the recirculation of exhaust gas of an internal-combustion engine, particularly an exhaust-gas-recirculation valve that has a 1-port/2-way valve and, simultaneously, works with reduced actuating forces. The system must further be more cost-effective and more error-tolerant in terms of wear and tear and tightness as compared to known systems. Moreover, it should be possible to adapt it to various parameter sets. In this connection it is also necessary to further provide a “fail safe” function with reduced reset forces.

This object is attained by the features of claim 1.

According to the invention the port of the inlet and the port of the outlet open at planes parallel to each other or in one plane, and the valve body is a seal plate capable of unblocking or blocking the port of the inlet and the port of the outlet in order to open or close the conduit passage between the inlet and the outlet.

Thus, the solution described here is comprised of a valve body (seal plate) and a housing of the exhaust-gas-recirculation valve with the two, preferably three, inlets or outlets. Instead of a piston as in the prior art, a seal plate (seal), preferably ceramic, is employed. The sealing function is guaranteed by solid bearing on the ports of the inlets and outlets (preferably made as conduits). All-around tightness as is common in pistons is eliminated here in an advantageous manner, and tolerances caused by temperatures, vibrations and the like can easily be compensated out.

The invention is further advantageously embodied by the features of the dependent claims and described below and further explained based on the figures.

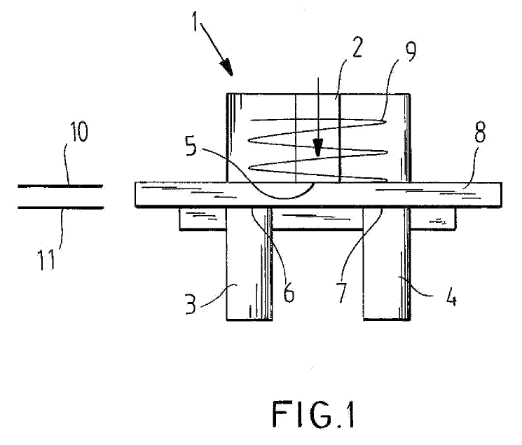

FIGS. 1 through 3 schematically show in some detail an exhaust-gas-recirculation valve with an unillustrated housing preferably made of a die-cast alloy. The unillustrated housing of the exhaust-gas-recirculation valve 1 has an inlet 2 and at least one additional outlet, preferably two outlets 3 and 4 (bypass and EGR circuit). The inlet 2, as well as outlets 3 and 4, are preferably embodied as passages connected via corresponding conduits with the intake-air manifold and the exhaust-gas manifold of the internal-combustion engine. The inlet 2 has one port 5, with the outlet, preferably both outlets 3 and 4, also have respective ports 6 and 7.

The ports 5, 6, and 7 in the illustrated embodiment according to FIG. 1 can be sealed or opened by a seal plate 8, and open at planes 10 and 11 parallel to each other. This means that the EGR and bypass conduits are positioned on opposite sides of the seal plate 8 from the inlet 2, the seal plate 8 preferably being made of ceramic. Here, the exhaust-gas pressure ensures bearing on the sealing surfaces of the ports 5, 6, and 7, and thus the tightness.

This means that the port 5 of the inlet 2 is on the one side of the seal plate 8, and the port 6 and 7 of the outlets 3 and 4 on the other side of the seal plate 8 in this illustrated embodiment.

To assist sealing of the ports, particularly of the ports 6 and 7, and to implement the “fail safe” function, the seal plate 8 is prestressed, which may for example be accomplished by a spring 9, preferably a coil spring. The spring closes the conduit passage between the inlet 2 and the at least additional outlet 3 and 4 if the electric hydraulic or pneumatic actuator (not shown here) fails, so that no exhaust gas can be recirculated into the intake manifold of the internal-combustion engine, thus still ensuring the internal-combustion engine's operation in the event of a defective actuator or a malfunction.

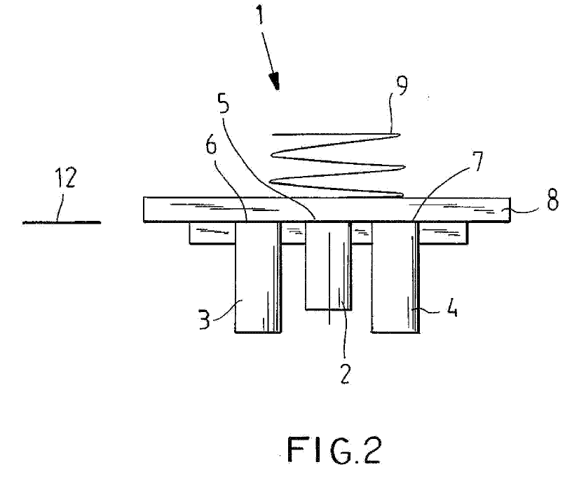

As an additional alternative illustrated embodiment FIG. 2 shows that the port 5 of the inlet 2 and the port 6 and 7 of the outlet 3 and 4 are on the same side of seal plate 8 together in a common plane 12. Thus, all connections (inlet 2 and outlet 3 and 4) are mounted on the one side of the seal plate 8. Here too, the seal's bearing on the seal seats is obtained by a prestress, preferably again by the spring 9. The advantage in this connection is that all tolerances of the system can be compensated upward (when viewing FIG. 2), and only the surface property of the sealing surface and the seal seats of the ports 5, 6, and 7 determine the tightness of the system. Thus, the exhaust-gas-recirculation valve 1 according to the invention can be developed and made significantly more simply and, accordingly, more cost-effectively.

As already known from the prior art, the seal plate is moved via an actuator depending on the internal-combustion engine's operating parameters, the parameters being captured and processed by a controller and corresponding sensors. The seal plate 8 according to the invention may be moved in a linear as well as in a rotational manner. The rotation and the embodiment of the exhaust-gas-recirculation valve 1 as a rotary valve is particularly advantageous in the present case. The functional characteristic of the exhaust-gas-recirculation valve, and thus the exhaust gas recirculation, can be very precisely regulated in dependence on the internal-combustion engine's operating parameters by the shape of the conduits of the inlet 2 and the outlets 3.

In an especially advantageous manner the seal plate is connected to the actuator via a coupling so that the seal plate can be uncoupled from the actuator in the event of a failure or malfunction. In such a case the prestress works on the seal plate 8 by the spring 9, so that the ports 5, 6, and 7 are sealed to cut exhaust gas recirculation and still guarantee the internal-combustion engine's continued operation.

To make a small actuator that uses the least possible designed space, is cost-intensive and shows low energy consumption, the coupling is connected to the actuator via a transmission. This still has the advantage that decoupling of the seal plate 8 from the actuator via the coupling 8 is guaranteed if the actuator malfunctions, whereas it is possible for the above-described small actuator to nonetheless be usable.

In a particularly advantageous manner the coupling is a magnet coupling capable of being electrically excited. The advantage is that the coupling can very easily be controlled, with the electrically excitable magnetic coupling being a hysteresis coupling to increase the effect in an additional advantageous embodiment. The hysteresis coupling offers the advantage of constant torque when powered up. After the voltage is cut (to have a “fail safe” function) the torque approaches zero, and hence no longer exists. Thus, the complete drive train is decoupled from the seal plate 8 and hence facilitates the desired “fail safe function” in the form of a small reset spring on the seal plate 8. A particular advantage in this connection is that the reset forces for this function can be kept low, and thus not overly burden the driving torque.

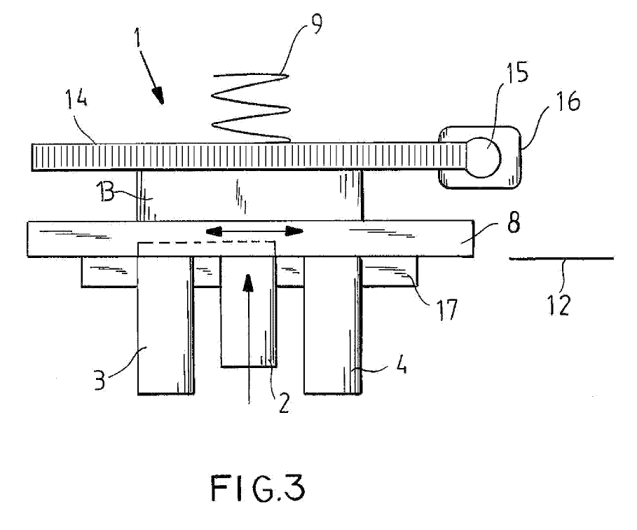

This is illustrated in FIG. 3, with the coupling preferably an electrically excitable magnetic hysteresis coupling being indicated at 13. A drive gear 14 meshing with a gear 15, preferably a worm, is connected to the coupling 13. The gear 15 forms with the drive gear 14 a simply designed and compact transmission, preferably a speed reducer. In this connection, the gear 15 is positioned on the actuator, preferably an electric motor 16. The actuator can also be embodied such that it works hydraulically or pneumatically. This means that the drive gear 14 is on the drive side of the coupling 13 (hysteresis coupling), with the drive gear 14 being able to be powered by a small electric actuator 16 via a transmission, preferably a worm gear. The advantage is that a complex planetary drive as in the prior art can be eliminated, and in addition the drive does not need to generate any holding torque. Thus, current consumption for the actuator (or alternatively the energy consumption of the pneumatic or hydraulic actuator) is considerably reduced and also presents no problem with dissipated heat energy.

In a further embodiment of the invention a sensor to capture the position of seal plate 8 is assigned to the seal plate 8. For example, by mounting a target magnet directly on the seal plate 8 and by sensing the position of the target magnet by a non-contact sensor, preferably a Hall sensor, the position of the actuator, particularly the seal plate 8, being measured directly and absolutely. Installation tolerances, power failure, fail safe function, and the like, advantageously have no impact on the measuring result. This means that the controller to which the position sensor is connected, receives the necessary information about the position of the seal plate 8 inside the housing of the exhaust-gas-recirculation valve 1 at all times, and that the information can also be taken into account when calculating the proportion of exhaust to be recirculated into the intake manifold of the internal-combustion engine. Moreover, this way a breakdown or malfunction of the position sensor can be taken into account advantageously by disconnecting the actuator from power in such a case, and thus immediately interrupting exhaust-gas recirculation, while simultaneously guaranteeing continued operation of the internal-combustion engine.

Overall, the invention offers the following advantages:
Fewer expenses than conventional systems,
No holding torque necessary from the actuator,
Low reset forces for a “fail safe function,”
Significantly smaller actuator necessary,
Reduced dissipated energy,
Reduced self-heating,
Elimination of planetary drive,
Defined excess torque,
Considerable simplification of sealing geometries,
No thermal expansion at the sealing element affecting critical functions,
Error-tolerant against installation tolerances,
Characteristics better adjustable to the desired application (design of the internal-combustion engine),
Significant reduction of energy consumption of the actuator,
Compact design of the exhaust-gas-recirculation valve.

### REFERENCE

1 Exhaust-gas-recirculation valve
2 Inlet
3 Outlet
4 Outlet
5 Port (of inlet 2)
6 Port (of outlet 3)
6 Port (of outlet 4)
8 Seal plate (8)
9 Spring
10 Plane of the port 5 of outlet 2
11 Plane of the ports 5, 8 of outlets 3 and 4
12 Common plane
13 Coupling
14 Drive gear
15 Gear
16 Actuator
17 Position sensor

1. An exhaust-gas-recirculation valve of an internal-combustion engine comprising a housing with an inlet for the supply of exhaust gas of the internal-combustion engine and at least one outlet for the recirculation of a portion of the exhaust gas into a combustion air supply of the internal-combustion engine, a conduit passage between the inlet and the outlet openable or closable by a valve body, and an actuator that moves the valve body to open or close the conduit passage between the inlet and the outlet wherein the port of the inlet and the port of the outlet open at planes parallel to each other or in one plane, and that the valve body is a seal plate capable of unblocking or blocking the port of the inlet and the port of the outlet in order to open or close the conduit passage between the inlet and the outlet.

2. The exhaust-gas-recirculation valve in accordance with claim 1 wherein the port of the inlet is on one side of the seal plate and the port of at least one outlet is on the other side of the seal plate.

3. The exhaust-gas-recirculation valve in accordance with claim 1 wherein the port of the inlet and the port of the outlet are on the same side of the seal plate.

4. The exhaust-gas-recirculation valve in accordance with claim 1 wherein the seal plate is prestressed.

5. The exhaust-gas-recirculation valve in accordance with claim 1 wherein the seal plate is ceramic.

6. The exhaust-gas-recirculation valve in accordance with claim 1 wherein the seal plate is coupled with the actuator via a coupling.

7. The exhaust-gas-recirculation valve in accordance with claim 6 wherein the coupling is connected to the actuator via a transmission.

8. The exhaust-gas-recirculation valve in accordance with claim 6 wherein the coupling is an electrically excitable magnetic coupling.

9. The exhaust-gas-recirculation valve in accordance with claim 8 wherein the electrically excitable magnetic coupling is a hysteresis coupling.

10. The exhaust-gas-recirculation valve in accordance with claim 1, further comprising
a sensor for detecting a position of the seal plate is associated with the seal plate.

11. In combination with an internal-combustion engine having an intake manifold and an exhaust system, an exhaust-gas-recirculation valve comprising:
a housing forming a passage and having at least one planar side formed with an inlet port connected to the exhaust system and an outlet port connected to the intake manifold;
a seal plate slidable on the side between a closed position blocking at least one of the ports and closing the passage and an open position unblocking both of the ports and opening the passage; and
actuator means for sliding the plate between the positions.

12. The exhaust-gas-recirculation valve defined in claim 11, further comprising
a spring biasing the plate toward the outlet port.

13. The exhaust-gas-recirculation valve defined in claim 11 wherein the housing has two sides extending parallel to each other and the inlet port is on one of the sides and the outlet port on the other of the sides.

14. The exhaust-gas-recirculation valve defined in claim 11 wherein the plate is a disk pivotal about an axis between the positions, the actuator including a drive motor and a worm-gear transmission between the motor and the disk.

15. The exhaust-gas-recirculation valve defined in claim 11 wherein the plate is ceramic.

16. The exhaust-gas-recirculation valve defined in claim 11 wherein there are two such outlet ports that open coplanar to each other.
